(19) United States
(12) Patent Application Publication
(10) Pub. No.: US 2010/0232604 A1
(43) Pub. Date: Sep. 16, 2010

(54) CONTROLLING ACCESS TO CONTENT USING MULTIPLE ENCRYPTIONS

(75) Inventor: Don C. Eklund, II, Yorba Linda, CA (US)

Correspondence Address: PROCOPIO, CORY, HARGREAVES & SAVITCH LLP, 525 B STREET, SUITE 2200, SAN DIEGO, CA, 92101, US

(73) Assignees: SONY CORPORATION, Tokyo (JP); SONY PICTURES ENTERTAINMENT INC., Culver City, CA (US)

(21) Appl. No.: 12/722,436

(22) Filed: Mar. 11, 2010

Related U.S. Application Data
(60) Provisional application No. 61/159,353, filed on Mar. 11, 2009.

(51) Int. Cl. H04N 7/167; H04L 9/08; H04L 9/14

(52) U.S. Cl. 380/210; 380/278

(57) ABSTRACT

Controlling access to content using multiple encryptions, including: receiving content comprising media data; first encrypting a substantial portion of the content using a primary key; selecting a subset of the substantial portion of the content; and second encrypting the selected subset of the content using a secondary key different from the primary key.

### CROSS-REFERENCE TO RELATED APPLICATIONS

This application claims the benefit of priority under 35 U.S.C. §119(e) of co-pending U.S. Provisional Patent Application No. 61/159,353, filed Mar. 11, 2009, entitled “Dual Encryption.” The disclosure of the above-referenced application is incorporated herein by reference.

### BACKGROUND

1. Field of the Invention

The present invention relates to controlling access to content, and more specifically, to controlling access to content using multiple encryptions.

2. Background

The use of digital communication systems has increased the need for encryption techniques which are secure against popular “cracking” methods at least for a sufficient length of time. Multiple encryption schemes, which encrypt entire data multiple times, can be used to provide enhanced security of the encrypted data. However, such multiple encryption schemes have disadvantages because they require multiple iterations through a cryptographic system. In the case of duplicate hardware blocks, this doubles or triples the gate count and power consumption in hardware renderings. In cases where execution of a single block is repeated, the maximum operating speed of the cryptographic system can be reduced to one-half or one-third depending on the number of iterations required.

### SUMMARY

The present invention provides for controlling access to content using multiple encryptions.

In one implementation, a method of controlling access to content using multiple encryptions is disclosed. The is method includes: receiving content comprising media data; first encrypting substantial portion of the content using a primary key; selecting a subset of the substantial portion of the content; and second encrypting the selected subset of the content using a secondary key different from the primary key.

In another implementation, a method of providing access to encrypted content on a server is disclosed. The method includes: receiving a request from a client to download a copy of the encrypted content, wherein the encrypted content was encrypted using a first encryption scheme having a primary key; selecting a subset of the encrypted content; encrypting the selected subset of the encrypted content using a second encryption scheme having a secondary key different from the primary key to produce doubly-encrypted content; and sending the doubly-encrypted content to the client.

In another implementation, a computer-readable storage medium storing a computer program for controlling access to content is disclosed. The computer program includes executable instructions that cause a computer to: receive content comprising media data; first encrypt substantial portion of the content using a primary key; select a subset of the substantial portion of the content; and second encrypt the selected subset of the content using a secondary key different from the primary key.

In a further implementation, an apparatus for controlling access to content using multiple encryptions is disclosed. The apparatus includes: means for receiving content comprising media data; first means for encrypting substantial portion of the content using a primary key; means for selecting a subset of the substantial portion of the content; and second means for encrypting the selected subset of the content using a secondary key different from the primary key.

Other features and advantages of the present invention will become more readily apparent to those of ordinary skill in the art after reviewing the following detailed description and accompanying drawings.

### BRIEF DESCRIPTION OF THE DRAWINGS

FIG. 1 shows a functional block diagram illustrating a process for controlling access to video data by encrypting the video data using two different encryption techniques with two keys in accordance with one implementation of the present invention.

FIG. 2 shows another functional block diagram illustrating a process for controlling access to video data by encrypting two copies of the video data for two different domains in accordance with another implementation of the present invention.

FIG. 3 shows one example of a decryption process corresponding to the example encryption process shown in FIG. 2.

FIG. 4 is a flowchart illustrating a process for controlling access to content using multiple encryption techniques in accordance with one implementation of the present invention.

### DETAILED DESCRIPTION

Certain implementations as disclosed herein provide for controlling access to content using multiple encryption schemes, for example, to provide improved security. The to term “encryption” as used herein refers to any type of scrambling performed on the content.

In one example implementation, all or substantial portion of the content (referred to as a first part of the content) is encrypted using a first encryption process and then a subset of the first part of the content (referred to as a second part of the content) is encrypted using a second encryption process. The subset is not necessarily contiguous data. Accordingly, the first part of the content is encrypted using the first encryption process and the second part is encrypted using both the first and the second encryption processes. The first encryption process is a common encryption, used for multiple domains or recipients. The second encryption process is specific to the domain or recipient. To access the content, both parts need to be decrypted, but in a reverse order. That is, the second part is decrypted first using the second decryption process corresponding to the second encryption and then the first part is decrypted next using the first decryption process corresponding to the first encryption. In an alternative implementation, the two parts of the content are encrypted separately. A subset is selected, dividing the data into two parts. The first part is encrypted using the first encryption process and the second part is encrypted using the second encryption process.

After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

Access to content can be controlled using multiple encryptions (e.g., two or more encryption schemes), which include at least a base encryption performed on all or substantial portion of the content using a primary key, and a targeted encryption performed on a subset of the content (e.g., critical portion(s)) using a secondary key. Further encryptions of the content and/or portion(s) of the content can be performed using additional keys. Thus, the term “multiple encryptions” can mean two or more different encryption techniques or same encryption performed with two or more different keys.

In one implementation, the targeted encryption includes any sort of modifications to the subset of the content, which may include scrambling the subset of the content. The purpose of the targeted encryption is to allow the content to be made uniquely secure for the intended target. This prevents unauthorized users from decrypting the content by obtaining the primary key which might be readily available. The intended target could be an individual or media device, a domain accessible to multiple individuals or media devices, a distributor, or other groupings.

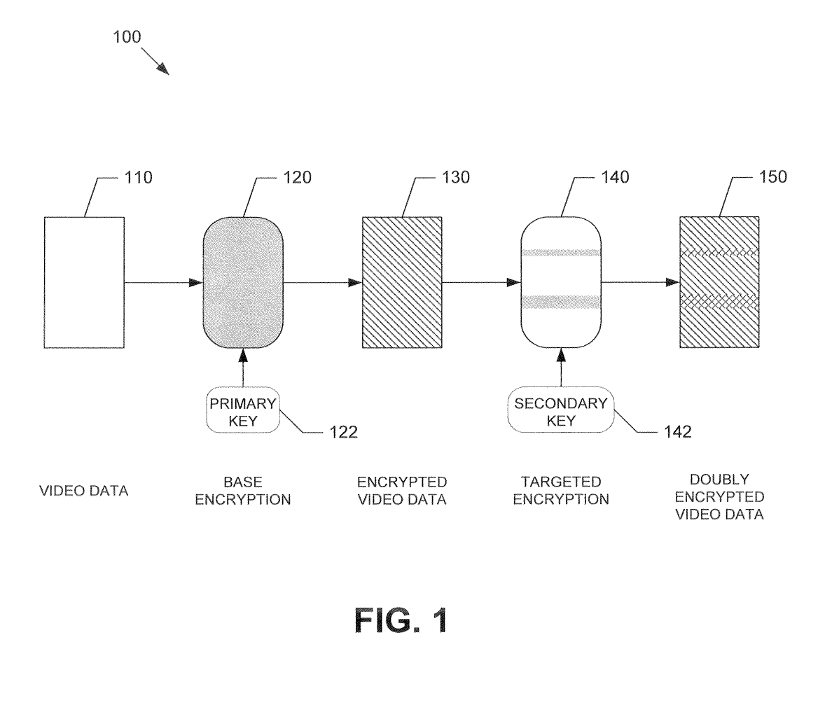

In one example implementation 100 shown in FIG. 1, video data 110 is encrypted using two keys 122, 142. An encryption technique 120 (i.e., the base encryption) is used to encrypt all or substantial portion of the video data 110 using a primary key 122, which produces encrypted video data 130. Another encryption technique 140 (i.e., the targeted encryption) is used to encrypt again portion(s) of the encrypted video data 130 (e.g., critical portion(s) of the video data) using a secondary key 142, which produces doubly encrypted video data 150. Thus, portion(s) of an encrypted data set can be selected so that the selected portion(s) are necessary to access the non-selected portion(s), for example, based on to encoding/decoding. In FIG. 1, the secondary key 142 is specific to a recipient or domain for which the video data is registered. To view the video represented by the video data, all the encrypted data needs to be decrypted, and so both keys are needed. That is, the secondary key is used to first decrypt the portion encrypted using the secondary key and then the primary key is used to decrypt the all or substantial portion that was encrypted using the primary key.

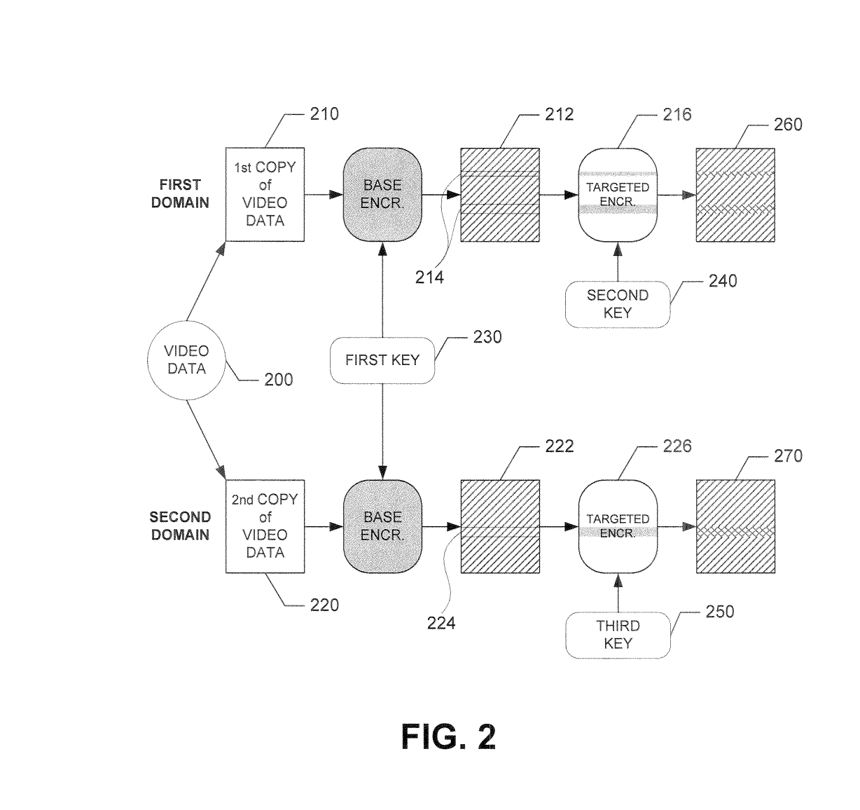

For example, as shown in FIG. 2, when a first copy 210 of the video data 200 is distributed to a first domain, the first copy 210 is encrypted using a first key 230 and a second key 240 to produce a doubly-encrypted video data 260. The first key 230 corresponds to the primary key used to encrypt the entire first copy 210 of the video data 200. The second key 240 corresponds to the secondary key used to encrypt portions of the first copy 210 of the video data. Further, when a second copy 220 of the video data 200 is distributed to a second domain, the second copy 220 is encrypted using the first key 230 and a third key 250, not the same second key 240. This produces a doubly-encrypted video data 270. Thus, for the second domain, the third key 250 corresponds to the secondary key used to encrypt portion of the second copy 220 of the video data. Devices in the first domain can decrypt the portions 214 of the doubly-encrypted video data 260 using the second key 240, and the devices in the second domain can decrypt the portion 224 of the doubly-encrypted video data 270 using the third key 250. Devices in the first domain and the second domain can complete the decryption process by each decrypting partially decrypted copies 212, 222 using the first key 230.

It should be noted, in FIG. 2, that the portions 214 of the encrypted first copy of the video data 212 encrypted' using the targeted encryption technique 216 are different from the portion 224 of the encrypted second copy of the video data 222 encrypted using the targeted encryption technique 226. However, in other implementations, same portion(s) of encrypted video data are encrypted again using a targeted encryption technique. Further, the encryption techniques 216, 226 used for targeted encryption can be same or different depending on the intended use of the copies of the video data.

Once content has been secured using multiple encryptions, multiple keys are distributed for decryption of the content. For example, in the case of a dual encryption of the content, a primary key is distributed to multiple recipients (or domains) and a secondary key is distributed to a single particular recipient (or a single domain) multiple times, wherein a different key is distributed each time. That is, the secondary key for a first recipient may be a second key, but for a second recipient it may be a third key.

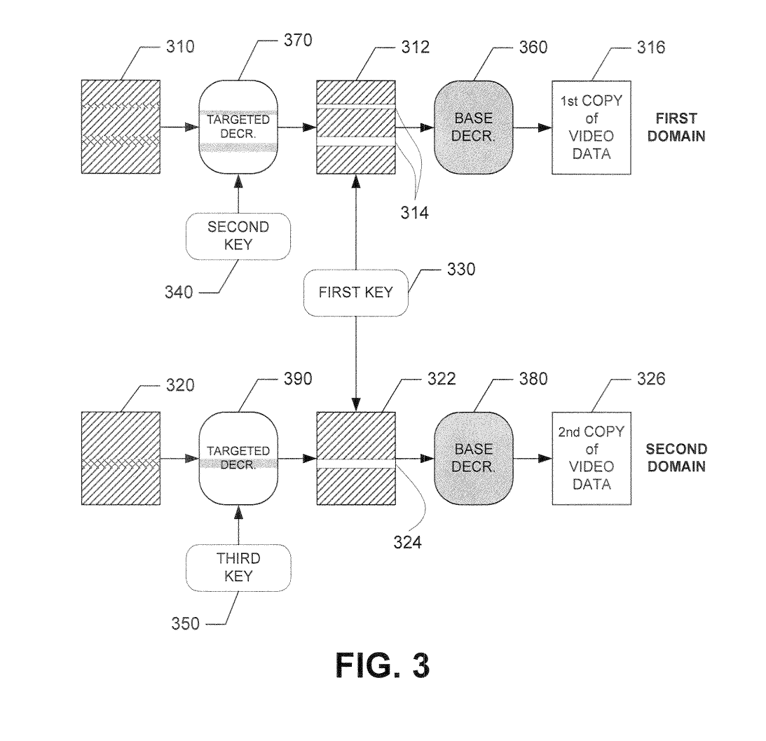

FIG. 3 shows one example of a decryption process corresponding to the example encryption process shown in FIG. 2. In this implementation, the first domain receives the first copy of the video data encrypted using the first key and the second key, and the second domain receives the second copy of the video data encrypted using the first key and the third key. The first domain also receives the first and second keys, and the second domain receives the first and third keys.

As shown in FIG. 3, when the first multiply-encrypted copy of the video data 310 is distributed to the first domain, the first multiply-encrypted copy 310 is decrypted using a second key 340 and then a first key 330. The second key 340 corresponds to the secondary key used to encrypt selected portions 314 of the first copy of the video data, and thus, the second key 340 is needed to decrypt (using a targeted decryption 370) the selected portions of the first multiply-encrypted copy 310. The first key 330 corresponds to the primary key used to encrypt the entire first copy of the video data, and thus, the first key 330 is needed to decrypt (using a base decryption 360) the entire content of the copy 312. The base decryption 360 produces the first copy of the video data 316.

Further, when the second multiply-encrypted copy of the video data 320 is distributed to the second domain, the second multiply-encrypted copy 320 is decrypted using a third key 350 and then the first key 330. The third key 350 corresponds to the secondary key used to encrypt selected portions of the second copy of the video data, and thus, the third key 350 is needed to decrypt (using a targeted decryption 390) the selected portions of the second multiply-encrypted copy of the video data 320. The first key 330 corresponds to the primary key used to encrypt the entire second copy of the video data, and thus, the first key 330 is needed to decrypt (using a base decryption 380) the entire content of the copy 322. The base decryption 380 produces the second copy of the video data 326.

In one specific implementation for encrypting and decrypting video data, copies of video data are distributed from a server to download recipients. On the server, copies of the video data are stored as encrypted data, encrypted using a first encryption having a first key. When a client requests to download a copy, the server creates or retrieves a key for the requestor (or requestor's domain). The server selects a subset of the encrypted video data and encrypts that subset again using a second encryption process and the second key. The subset can be a small part (e.g., 1-2%) of the total data, but preferably includes data that is necessary to decode and display the video data, at least in part. The subset can be determined at the time of encryption or can be based on data retrieved, such as from a table indexing video data content, requestors, or domains.

Accordingly, the copy received by the client has two parts. The first part of the video data, making up the majority of the video data (e.g., 98%) is encrypted using a first encryption having a first key. The second part of the video data, making up the remainder of the video data (e.g., 2%), is encrypted using a second encryption having a second key. The second part is also encrypted using the la first encryption process so the second part will be decrypted twice, once for the second encryption and then again for the first encryption. The keys are incompatible, such that the first key cannot decrypt the data encrypted with the second encryption.

In one implementation, the video data resulting from decrypting only the first part is not sufficient to view the encoded video (e.g., due to data in the second part that is necessary for decoding the video data in the first part). In another implementation, some of the video data in the first part can be viewed without the second part data, but not all and/or at reduced visual quality. Accordingly, to view high quality video, for example, it is necessary to decrypt both the first and the second parts of the video data corresponding to the video. One benefit of this multiple encryptions is that if one key is compromised the video data as a whole is still secure. Since the first encryption is a common scheme, multiple copies of the video data can be encrypted using the first encryption. Further, since the second encryption is a target-specific encryption, only a single copy (or fewer copies made for a single domain) can be made using the second encryption.

For example, a first copy of the video data is encrypted using the first encryption and the second encryption. A second copy of the video data is encrypted using the first encryption and a third encryption, different from the second encryption. Alternatively, the first and second copies are both encrypted using the second encryption, but different keys are used for the second encryption of the copies. In another alternative, the parts of the video data that are encrypted using the first and second encryptions are different between the two copies. For example, 98% of the video data is encrypted using the first encryption and 2% of the video data is encrypted using both encryptions in the first copy, but 97% of the video data is encrypted using the first encryption and 3% of the video data is encrypted using both encryptions in the second copy. In another example, the same percentages are used for both first and second copies but different parts are encrypted the first and second copies. For example, the first 98% of the video data is used for the first copy, whereas the last 98% of the video data is used for the second copy.

In a domain-based implementation, multiple copies can be made using the same second encryption or second key, but those copies will only be accessible to devices within (or registered with) a particular domain. The second key is specific to that domain and so only devices of that domain will have access to the second key and be able to decrypt the second part.

In another implementation, the second parts of two different copies are the same data but are encrypted differently (e.g., different keys). In this way, a copy or a copy of a copy (super-distribution) can be transferred to another recipient or another domain. To access the transferred copy, the recipient of the transferred copy decrypts both the first and second parts of the data. The recipient can decrypt the first part because it was encrypted using a common encryption process, but the recipient will need a new second part because the second part was encrypted using the encryption targeted to the original recipient. The new recipient can request and download a new second part from a server system. The new second part is encrypted for the new recipient and replaces the second part of the transferred copy. Accordingly, the new recipient can decrypt the second part as well and access the clear data. In an alternative implementation, the recipient of the transferred copy requests an update from the server and the server creates an update file (e.g., a delta file) to modify both the first and second portions of the video data. When the new recipient applies the update file to the transferred copy, the first part and second part are modified according to the update file so that the new recipient can then decrypt both the first and second parts of the data.

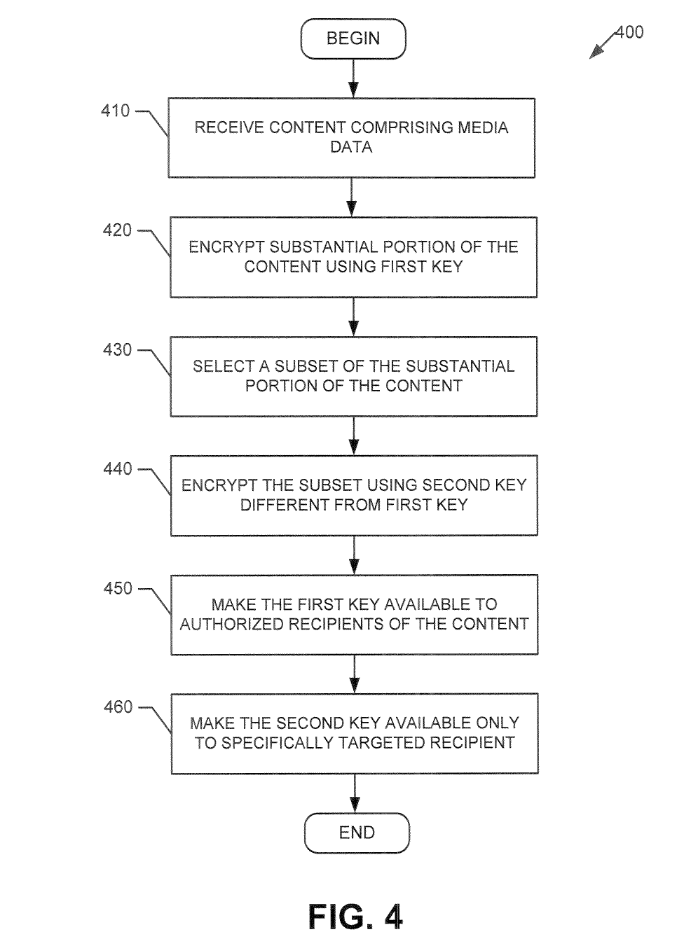

FIG. 4 is a flowchart 400 illustrating a process for controlling access to content using multiple encryption schemes in accordance with one implementation of the present invention. In the illustrated implementation of FIG. 4, content comprising media data is received, at box 410. In one implementation, the content is received from a content provider on recording media such as DVD or Blu-ray Disc (BD). Once the content is received, substantial portion of the content is encrypted, at box 420, using a first key. At box 430, a subset of the substantial portion of the content is select for further encryption(s). The subset selected may include some critical portion(s) which are necessary to access the non-selected portion(s), for example, based on encoding/decoding. In one implementation, the subset includes portions of the content that are contiguous. In another implementation, the subset includes portions of the content that are not contiguous.

At box 440, the selected subset of the content is encrypted again using a second key different from the first key. Further, the second encryption of the selected subset may involve using an encryption technique different from the encryption technique used to encrypt the substantial portion of the content with the first key. In one implementation, the first key is made available, at box 450, to all authorized recipients (or domains) of the content. Further, at box 460, the second key is made available only to a specifically targeted recipient (or domain). Means for distributing the first key includes public distribution channels such as network, domain, etc. Means for distributing the second key includes private distribution channels such as email, text message, etc.

The description herein of the disclosed implementations is provided to enable any person skilled in the art to make or use the invention. Numerous modifications to these implementations would be readily apparent to those skilled in the art, and the principals defined herein can be applied to other implementations without departing from the spirit or scope of the invention. For example, although the content is described as being encrypted twice (once for substantial portion of the content using a first encryption technique and again for a subset using a second encryption technique), the content can be encrypted multiple times with different combinations of encryption techniques, keys, and portion(s), of the content. Thus, the invention is not intended to be limited to the implementations shown herein but is to be accorded the widest scope consistent with the principal and novel features disclosed herein.

Various implementations of the invention are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a computer-readable storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Additionally, the steps of a method or technique described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

1. A method of controlling access to content using multiple encryptions, the method comprising:
receiving content comprising media data;
first encrypting a substantial portion of the content using a primary key;
selecting a subset of the substantial portion of the content; and
second encrypting the selected subset of the content using a secondary key different from the primary key.

2. The method of claim 1, wherein the selected subset of the substantial portion of the content comprises
at least one critical portion of the content which is necessary to access at least one non-selected portion of the content.

3. The method of claim 2, wherein the at least one critical portion of the content comprises
at least one portion of the content that is contiguous.

4. The method of claim 1, wherein an encryption technique used for first encrypting is different than an encryption technique used for second encrypting.

5. The method of claim 1, further comprising
providing the primary key to all authorized recipients of the content.

6. The method of claim 5, further comprising
providing the secondary key to only a specifically targeted recipient of the content.

7. The method of claim 1, wherein second encrypting comprises
any sort of modifications to the subset of the content.

8. The method of claim 7, wherein the modifications comprise
scrambling the subset of the content.

9. The method of claim 1, wherein the selected subset comprises
at least one portion of the content which is not part of the substantial portion of the content.

10. The method of claim 1, wherein a different subset of the substantial portion of the content is selected for each specifically targeted recipient of the content.

11. The method of claim 1, further comprising
distributing the secondary key comprising a second key and a third key to specifically targeted recipients of the content.

12. The method of claim 11, wherein the second key is provided to a first specifically targeted recipient of the content while the third key is provided to a second specifically targeted recipient of the content.

13. The method of claim 11, wherein each recipient of the specifically targeted recipients of the content is a specific domain.

14. The method of claim 13, wherein devices connected to the specific domain are able to decrypt the selected subset of the content.

15. A method of providing access to encrypted content on a server, the method comprising:
receiving a request from a client to download a copy of the encrypted content,
wherein the encrypted content was encrypted using a first encryption scheme having a primary key;
selecting a subset of the encrypted content;
encrypting the selected subset of the encrypted content using a second encryption scheme having a secondary key different from the primary key to produce doubly-encrypted content; and
sending the doubly-encrypted content to the client.

16. The method of claim 15, wherein the subset of the encrypted content is necessary to decode and display at least part of the content.

17. The method of claim 15, wherein the primary key allows partial decryption of the content so that the content can be viewed at reduced visual quality.

18. A computer-readable storage medium storing a computer program for controlling access to content, the computer program comprising executable instructions that cause a computer to:
receive content comprising media data;
first encrypt substantial portion of the content using a primary key;
select a subset of the substantial portion of the content; and
second encrypt the selected subset of the content using a secondary key different from the primary key.

19. The storage medium of claim 18, further comprising executable instructions that cause a computer to
provide the primary key available to all authorized recipients of the content.

20. The storage medium of claim 19, further comprising executable instructions that cause a computer to
provide the secondary key available to only a specifically targeted recipient of the content.

21. An apparatus for controlling access to content using multiple encryptions, the apparatus comprising:
means for receiving content comprising media data;
first means for encrypting substantial portion of the content using a primary key;
means for selecting a subset of the substantial portion of the content; and
second means for encrypting the selected subset of the content using a secondary key different from the primary key.

22. The apparatus of claim 21, further comprising
means for distributing the primary key available to all authorized recipients of the content.

23. The apparatus of claim 21, further comprising
means for distributing the secondary key available to only a specifically targeted recipient of the content.
